(19) United States
(12) Patent Application Publication
(10) Pub. No.: US 2007/0014207 A1
(43) Pub. Date: Jan. 18, 2007

(54) METHOD OF TRACK SEEKING IN AN OPTICAL DISC DRIVE

(76) Inventors: Yi-Long Hsiao, Taoyuan County (TW); An-Te Liu, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/456,214

(22) Filed: Jul. 10, 2006

(30) Foreign Application Priority Data
Jul. 14, 2005 (TW) 094124227

(51) Int. Cl. G11B 7/00

(52) U.S. Cl. 369/44.28

(57) ABSTRACT

A seeking method of an optical disc drive includes steps of (a) calculating a deviation signal value between a location of a fine actuator and a coarse actuator, (b) judging whether or not the deviation signal value is within a deviation signal threshold interval, (c) outputting a characteristic value to push the coarse actuator if the deviation signal value is not within the deviation signal threshold interval, and (d) jumping to a target track.

### BACKGROUND OF THE INVENTION

1. Field of the Invention

The invention relates to an optical disc drive, and more particularly, to a track seeking method of an optical disc drive.

2. Description of the Prior Art

Allowing for track seeking operations while reading an optical disc, a typical optical disc drive is composed of a coarse actuator, a sliding carriage, a guided fine actuator, and an object lens. The coarse actuator is controlled from a direct current (DC) motor and a screw, and the feeding range of the coarse actuator is greater than the fine actuator. The fine actuator is coupled to the coarse actuator to thereby create an actuator unit. Normally, the fine actuator is adjusted by a voice coil motor. When the fine actuator skips tracks to the edge of the coarse actuator, in order to continue the seeking operation, the coarse actuator must move and allow the fine actuator to be able to continue performing the seeking operation. If the coarse actuator allows the fine actuator actually move to the edge of the coarse actuator, the seeking operating of the fine actuator will fail.

Please refer to FIG. 1 showing a typical optical disc drive allowing a coarse actuator and a fine actuator to move together according to the related art. As shown in FIG. 1, a speed command 11 is issued to give commands from the system to control the movement speed of the fine actuator 18. The speed detector 15 detects the actual speed of the fine actuator 18. When the fine actuator 18 performs a speed adjustment, the speed command 11 and a speed value outputted by the speed detector 15 are both inputted to a control unit 12 to calculate the error. The control unit 12 simultaneously outputs a small adjustment control signal to the fine drive circuit 13 to control the fine actuator 18 for performing track seeking, and outputs a coarse adjustment control signal to the coarse drive circuit 14 to control the current motor 16 to push the coarse actuator 17. The coarse adjustment control signal allows the coarse actuator 17 to match the seeking speed of the fine actuator 18 and prevents seeking error. However, in this type of adjustment, the fine actuator 18 and the coarse actuator 17 are both simultaneously performing adjustments. There is no way to guarantee that the fine actuator 18 will be positioned at a center region of the coarse actuator 17. Therefore, seeking failures are very common.

Furthermore, because the accuracy of the seeking operations of the optical disc drive depends on the difference of operation mechanism and the precision of the control unit 12, if the driving power cannot push the coarse actuator 17, the drive power will continuously build up until it overcomes the static frictional force and can move the coarse actuator 17. If the drive power for moving the coarse actuator 17 is too large, the correction to the coarse actuator 17 will then be too large and the fine actuator will no longer be able to make a matching adjustment. Such a situation will result in a slow response time or a correction failure, thereby causing a seek operation error.

Because of the above-described problems, how to improve adjustment and driving signals to maintain the distance between the fine actuator and the coarse actuator is a current problem required to be solved. It would also be beneficial if the fine actuator was maintained at a center region of the coarse actuator. These are difficulties currently facing the optical disc drive industry.

### SUMMARY OF THE INVENTION

One objective of the claimed invention is therefore to provide a seeking method of an optical disc drive to solve the above-mentioned problems by comparing a deviation signal of the positions of a fine actuator and a coarse actuator. If the deviation signal falls outside of the range of a deviation signal threshold interval, outputting a characteristic value to a DC motor. The characteristic value can be a voltage value or a current value, makes the deviation signal fall within the range of the deviation signal threshold interval, allows the fine actuator to fall within a center range of the coarse actuator, prevents the fine actuator from reaching the edge of the coarse actuator, and avoids errors during track seeking operations.

Another objective of the claimed invention is to provide a seeking method of an optical disc drive checking if the coarse actuator is actually moving according to whether the deviation signal increases or decreases after inputting the characteristic value to push the coarse actuator. If the coarse actuator is not moving, a larger characteristic signal is continued to be input until the characteristic value is large enough to move the coarse actuator. In this way, the characteristic value is gradually changed to change the drive signal strength and to increase the track seeking efficiency.

Yet another objective of the claimed invention is to provide a track seeking method for an optical disc drive to decide, before performing track seeking operations, the corresponding drive signal for the characteristic value of the coarse actuator according to data searching the commands for already executed repeated direction seeking commands during the same seek operation. In this way, the claimed invention is able to quickly increase the characteristic value to push the coarse actuator, and to increase the speed of the response to the drive signal by the coarse actuator.

According to an exemplary embodiment of the claimed invention, the method of track seeking in an optical disc drive comprises the following steps: (a) detecting a displacement between a position of a fine actuator and a position of a coarse actuator to thereby detect a deviation signal value; (b) comparing the deviation signal value with a deviation signal value threshold range to determine if the deviation signal value is within the deviation signal threshold range; (c) if the deviation signal value is judged to be not within the deviation signal value threshold range, outputting a characteristic value to push the coarse actuator; and (d) seeking to a target track.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a typical optical disc drive allowing a coarse actuator and a fine actuator to move together according to the related art.

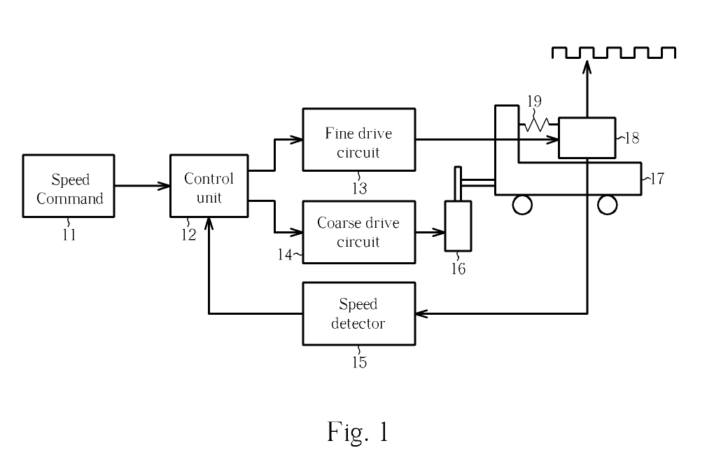

FIG. 2 shows an optical disc drive during track seeking operations according to an exemplary embodiment of the present invention.

FIG. 3 shows a flowchart of a track seeking method according to a first exemplary embodiment of the present invention.

FIG. 4 shows a flowchart of a track seeking method according to a second exemplary embodiment of the present invention.

FIG. 5 illustrates experimental data results for the first embodiment of the present invention.

FIG. 6 illustrates experimental data results for the second embodiment of the present invention.

### DETAILED DESCRIPTION

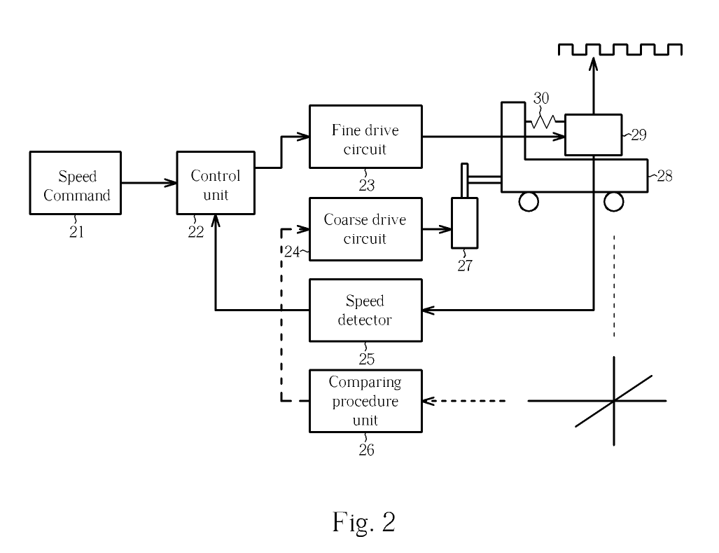

FIG. 2 shows an optical disc drive during track seeking operations according to an exemplary embodiment of the present invention. As shown in FIG. 2, the optical disc drive includes a speed command 21, a control unit 22, a fine drive circuit 23, a coarse drive circuit 24, a speed detection unit 25, a comparing procedure unit 26, a direct current (DC) motor 27, a coarse actuator 28, a deviation signal detection device 281, a fine actuator 29, and a movable mechanism 30. The speed command 21 corresponds to a system command to request the movement speed of the fine actuator 29. When the fine actuator 29 is performing speed adjustments, the speed signal of the speed command 21 and the speed detecting unit 25 are inputted to the control unit 22. The difference between the two signals is calculated by the control device 22, and a fine adjustment control signal is outputted to the fine drive circuit 23 to drive the fine actuator 29, which thereby achieves a feedback path for controlling the track seeking operation. The fine actuator 29 is coupled to the movable mechanism 30 on the coarse actuator 28. The corresponding displacement between the fine actuator 29 and the coarse actuator 28 is detected by the deviation detecting device 281, which converts the corresponding displacement signals into a deviation signal value. The deviation signal value is inputted to the comparing procedure unit 26 for a comparison operation, and the result of the comparison operation is a drive signal inputted to the coarse drive circuit 24. This allows the coarse drive circuit 24 to properly control the DC motor 27. The DC motor 27 again pushes the coarse actuator 28, allowing the coarse actuator 28 to be able to match the speed and movement of the fine actuator 29. Furthermore, the corresponding displacement between fine actuator 29 and the coarse actuator 28 is maintained within a predetermined deviation signal value threshold region.

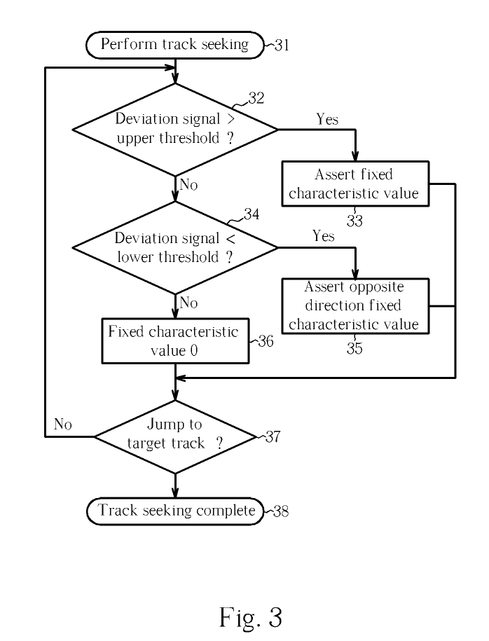

Please refer to FIG. 3 showing a flowchart of a track seeking method according to a first exemplary embodiment of the present invention. An important idea of this embodiment is utilizing a provided characteristic value to control the driving power and thereby ensure the displacement deviation signal for the fine actuator 28 and the coarse actuator 19 is within the displacement deviation threshold range, and then performing the seeking operation. According to this embodiment, the seeking operation includes the following steps:

Step 31: When a speed command is received by the control unit 22, the control unit 22 drives the fine drive circuit 23 to drive the fine actuator 29 to perform the seeking operation.

Step 32: The comparing procedure unit 26 then compares displacement between the fine actuator 29 and the coarse actuator 28 to obtain a deviation signal value and to determine whether or not the deviation signal value is greater than an upper limit of a predetermined deviation signal value threshold range. If yes, control proceeds to step 33; otherwise, control proceeds to step 34.

Step 33: A determined characteristic value is provided to the coarse drive signal circuit 24 to drive the DC motor 27. The characteristic value could be implemented as an electrical voltage or an electrical current. Driving the coarse actuator 28 causes the fine actuator 29 to move toward the center of the coarse actuator 28, and this in turn causes the displacement between the fine actuator 29 and the coarse actuator 28 (i.e., the resulting deviation signal value) to fall within the predetermined characteristic value range. Next, proceed to step 37 to judge whether or not the coarse actuator 28 has arrived at the target track.

Step 34: The comparing procedure unit 26 then compares the deviation signal value obtained according to the displacement between the fine actuator 29 and the coarse actuator 28 to determine whether the deviation signal value is less than the lower limit of the predetermined deviation signal value threshold range. If yes, control is passed to step 35; otherwise, control is passed to step 39.

Step 35: An opposite direction characteristic value is passed to the coarse drive signal circuit 24 to drive the DC motor 27, and to thereby drive the coarse actuator 28. This causes the fine actuator 29 to move toward the center of the coarse actuator 28. Therefore, the displacement deviation signal value of the fine actuator 29 and the coarse actuator 28 falls within the predetermined deviation signal value range. Afterwards, control is passed to step 37 to execute a judging operation to determine whether or not the coarse actuator 28 has jumped to the target track.

Step 36: When the deviation signal value obtained according to the displacement between the fine actuator 29 and the coarse actuator 28 falls within the predetermined deviation signal value threshold, a fixed characteristic value of 0 is inputted. In this way, the coarse actuator 28 is not moved and this allows the fine actuator 29 to maintain its position near the center of the coarse actuator 28.

Step 37: Judgment is made of whether or not the seeking operation has arrived at the target track. If yes, control is passed to step 38; otherwise, control is returned to after step 31 to repeat performing the seeking operation.

Step 38: The seeking operation is finished.

According to the above-described first embodiment of the track seeking operation of the present invention, by comparing the displacement deviation signal of the fine actuator and the coarse actuator with a predetermined deviation threshold range, if the displacement deviation signal falls outside the predetermined deviation threshold range and is larger than the predetermined deviation threshold range, a fixed value of a characteristic value is utilized to drive the coarse actuator 28, which thereby allows the fine actuator 29 to maintain its position at the center of the coarse actuator 28. This prevents the seeking operation of the fine actuator 29 from failing due to reaching the edge of the coarse actuator 28 and thereby increases the efficiency of track seeking operations.

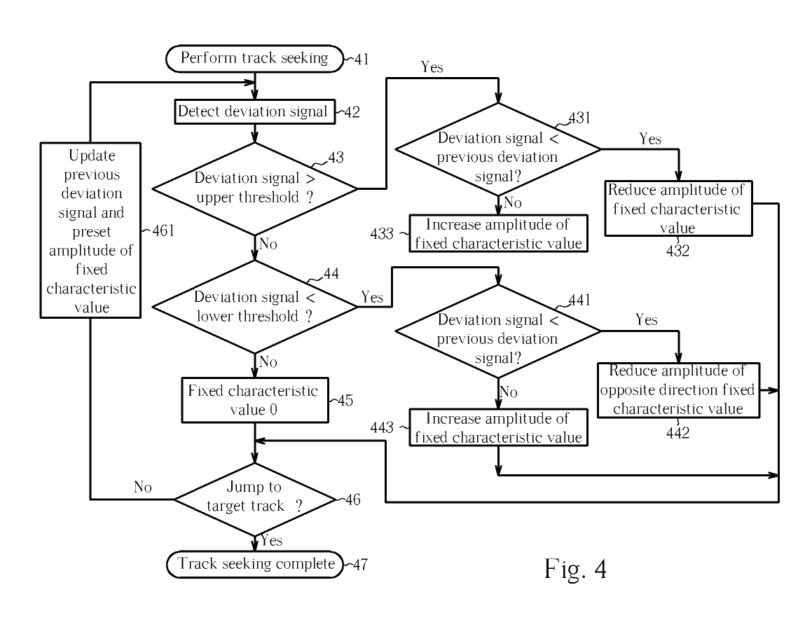

Please refer to FIG. 4 showing a flowchart of a track seeking method according to a second exemplary embodiment of the present invention. The track seeking method of the second embodiment also utilizes the functions of the structure shown in FIG. 2 and is very similar to the method of the first embodiment. However, in this embodiment, the fixed characteristic value undergoes repetitive increases or decreases. The track seeking method according to the second embodiment includes the following steps:

Step 41: Start a track seeking operation.

Step 42: Detect the displacement deviation signal between the fine actuator 29 and coarse actuator 28.

Step 43: Compare the deviation signal with a upper limit of a predetermined deviation signal threshold value range. If the deviation signal is greater than the upper limit of the predetermined deviation signal threshold value then proceed to step 431; otherwise, proceed to step 44.

Step 431: Compare the deviation signal with a previous deviation signal. If the deviation signal is less than the previous deviation signal, proceed to step 432; otherwise, proceed to step 433.

Step 432: The deviation signal is less than the previous deviation signal and this indicates the amplitude of the fixed characteristic value utilized by the DC motor 27 to drive the coarse actuator 28 exceeds what is required to correct the displacement between the coarse actuator 28 and the fine actuator 29. Because of this, reduce the amplitude of the fixed characteristic value signal by a predetermined value. Afterwards, proceed to step 46 to determine whether or not the target track has been reached.

Step 433: The fixed characteristic value amplitude of the DC motor 27 to drive the coarse actuator 28 does not have the ability to correct the displacement deviation between the coarse actuator 28 and the fine actuator 29. Therefore, increase the amplitude of the fixed characteristic value. Afterwards, proceed to step 46 to determine whether or not the target track has been reached.

Step 44: Compare the deviation signal with the lower limit of the predetermined deviation signal value threshold. If the deviation signal is less than the lower limit of the predetermined deviation signal value threshold, proceed to step 441; otherwise, proceed to step 45.

Step 441: Compare the deviation signal with the previous deviation signal. If the deviation signal is greater than the previous deviation signal, proceed to step 442; otherwise, proceed to step 443.

Step 442: Currently, the amplitude of the fixed characteristic value utilized by the DC motor 27 to drive the coarse actuator 28 exceeds the amplitude required to correct the displacement deviation between the coarse actuator 28 and the fine actuator 29. Because of this, reduce the amplitude of the characteristic signal by a predetermined value. Afterwards, proceed to step 46 to determine whether or not the target track has been reached.

Step 443: The fixed characteristic value amplitude of the DC motor 27 to drive the coarse actuator 28 does not have the ability to correct the displacement deviation between the coarse actuator 28 and the fine actuator 29. Therefore, increase the amplitude of the fixed characteristic value. Afterwards, proceed to step 46 to determine whether or not the target track has been reached.

Step 45: The deviation signal has already entered the deviation signal value threshold range. Therefore output a fixed characteristic value of 0. In this way, the coarse actuator 28 is not moved.

Step 46: Judge whether or not the seeking operation has arrived at the target track. If yes, proceed to step 48; otherwise, proceed to step 461.

Step 461: Store the currently obtained deviation signal according to the detecting operation as a previous deviation signal. Also store the current amplitude of the fixed characteristic value as the previously used amplitude of the fixed characteristic value. Afterwards, return to step 42 to repeat determining the deviation signal value of the coarse actuator 29 and the fine actuator 28.

Step 47: The seeking operation is finished.

In the above second embodiment, after inputting a characteristic value to push the coarse actuator, the adjustment of the coarse actuator is inspected according to a rise or fall of the deviation signal. The rise or fall of the deviation signal is utilized to decide whether to increase or decrease the size of the inputted characteristic value. In this way, coarse actuator is pushed, and the characteristic value is repeatedly adjusted to thereby change the strength of the drive signal. Therefore, in the condition that the optical disc drive cannot smoothly drive the coarse actuator 28 to allow the fine actuator 29 to maintain a position in the center region, the amplitude of the characteristic value is gradually increased. As a result, it is very efficient and accurate to maintain the corresponding positional range between the coarse actuator 28 and the fine actuator 29.

Using the same logic, in step 416 of the above-described second embodiment, in addition to storing the currently obtained deviation signal according to the detecting operation as the previous deviation signal and storing the current amplitude of the fixed characteristic value as the previously used amplitude of the fixed characteristic value, additional information can also be stored. For example, information from the same search command can be stored such as the number of increasing or decreasing adjustments made to fixed characteristic value for the same direction, and the number of times that the same direction track seeking operations have been successively performed according to the same data search commands cycle. Afterwards, the number of times can be multiplied by a predetermined ratio of the fixed characteristic value. The result can be updated as the previously utilized characteristic value. For example, when continuously performing track seeking in the same direction for the 3^{rd} time, assuming the ratio value is set as 25%, the track seeking time 3 is multiplied by the ratio value of 25%, and at the start of the 3^{rd} track seeking operation, the characteristic value amplitude is increased by 75% to drive the coarse actuator 28. This increases the speed of the correction between the displacement difference of the coarse actuator 28 and fine actuator 29, and increases the speed of the coarse actuator drive response.

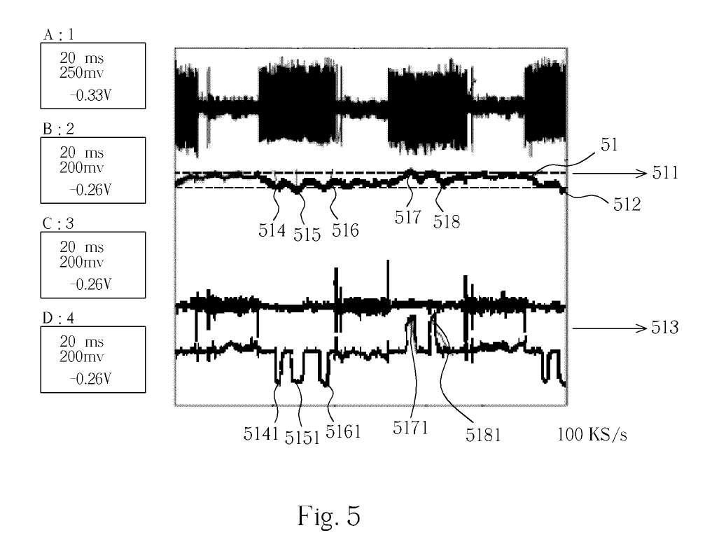

The following two experimental data results are directed at the track seeking embodiments of the present invention and show a voltage value driving the coarse actuator. FIG. 5 corresponds to the first embodiment of the present invention and shows that when the voltage obtained corresponding to displacement deviation signal between the fine actuator 29 and coarse actuator 28 falls outside the range of the voltage threshold, the inputted voltage makes the voltage value return to the threshold range. As shown in FIG. 5, looking at the second wave signal 51, when the voltages 514, 515, 516 are less than the lower limit 512 of the voltage threshold, inputting three times the negative voltages 5141, 5151, 5161 (see fourth wave signal 53) causes the obtained voltage return within the threshold range. Continuing, when voltages 517, 518 are greater than the upper limit 511 of the voltage threshold, inputting two times the positive voltages 5171, 5181 causes the obtained voltage return to within the threshold voltage range. This indeed reflects the above-described operation of the first embodiment.

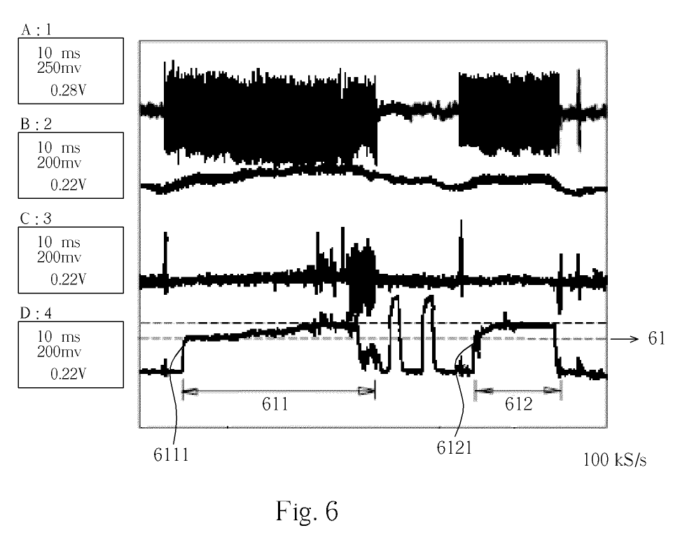

FIG. 6 shows experimental data results for the second embodiment of the present invention. As illustrated in FIG. 6 by the fourth wave 61, when performing track seeking of the first track 611 for the first time, the strength of the input voltage 6111 is not sufficient. This results in the voltage obtained from the displacement deviation of the fine actuator 29 and the coarse actuator 28 falling outside the voltage threshold range. When performing the same data search command for the second time in the same direction 612, the coarse actuator start drive voltage 6121 is increased. Because of this, the voltage obtained from the displacement deviation of the coarse actuator 28 and fine actuator 29 falls within the voltage threshold range.

Therefore, by comparing the deviation signal obtained corresponding to the positions of the fine actuator and the coarse actuator, the location of the fine actuator can be accurately maintained within a corresponding range on the coarse actuator. This ensures the pick-up head will be successful in performing the track seeking operation and also increases optical disc drive efficiency. At the same time, the fixed characteristic value outputted by the driving circuit driving the coarse actuator maintains the fine actuator within a corresponding positional range on the coarse actuator, and this can provide adjustment according to the seeking operation times and deviation signal correction situation. Furthermore, this increases the stability of the optical disc drive track seeking mechanism. The present invention indeed satisfies the novelty, advancement, and usefulness requirements, as provided by the appended claims.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of track seeking in an optical disc drive, the method comprising the following steps:
(a) detecting a deviation signal value corresponding to a displacement between a position of a fine actuator and a position of a coarse actuator;
(b) comparing the deviation signal value with a deviation signal value threshold range to determine if the deviation signal value is within the deviation signal threshold range;
(c) if the deviation signal value is judged to be not within the deviation signal value threshold range, outputting a characteristic value to push the coarse actuator; and
(d) seeking to a target track.

2. The method of claim 1, wherein the deviation signal value generated in step (a) is generated by a deviation signal value detecting unit.

3. The method of claim 1, wherein step (c) further comprises judging whether of not the deviation signal value exceeds an upper limit of the deviation signal value threshold range, and outputting a fixed characteristic value to push the coarse actuator if the deviation signal value exceeds the upper limit of the deviation signal value threshold range.

4. The method of claim 1, wherein step (c) further comprises judging whether of not the deviation signal value is less than a lower limit of the deviation signal value threshold range, and outputting an opposite direction fixed characteristic value to push the coarse actuator if the deviation signal value is less than the lower limit of the deviation signal value threshold range.

5. The method of claim 1, wherein step (d) further comprises judging whether or not the target tracked has been reached; if the target track has been reached, ending the track seeking, and if the target track has not been reached repeating step (a) to again detect the deviation signal value.

6. The method of claim 5, wherein in step (d) before repeating step (a), the method further includes step (d-1) updating a previous deviation signal and an amplitude of a previous fixed value characteristic value.

7. The method of claim 6, wherein step (d-1) further comprises updating a next track detected deviation signal and an amplitude of a used fixed characteristic value as a previous deviation signal and a fixed value characteristic amplitude, respectively.

8. The method of claim 6, wherein after step (c) the method further comprising step (c-b 1) judging whether or not a drive signal according to the fixed characteristic value amplitude has corrected the coarse actuator and fine actuator displacement deviation, if yes, decreasing the fixed characteristic amplitude, if no, increasing the fixed characteristic value amplitude.

9. The method of claim 8, wherein increasing or decreasing the fixed value characteristic value amplitude is performed by utilizing a fixed number.

10. The method of claim 6, wherein step (d-1) further comprises storing a number of times for successive same directions of track seeking.

11. The method of claim 10, wherein step (d-1) further comprises multiplying the number of times by a predetermined ratio of the fixed characteristic value to thereby update a preset fixed value characteristic value.

12. The method of claim 11, wherein the predetermined ratio is 25%.

13. The method of claim 1, wherein the characteristic value is an electric voltage.

14. The method of claim 1, wherein the characteristics value is an electric current.
